(19) United States
(12) Patent Application Publication
(10) Pub. No.: US 2024/0391223 A1
(43) Pub. Date: Nov. 28, 2024

(54) PACKAGING FILM

(71) Applicant: AMCOR FLEXIBLES NORTH AMERICA, INC., Neenah, WI (US)

(72) Inventor: Florian CHAPALAIN, Marcq-en-Baroeul (FR)

(21) Appl. No.: 18/696,833

(22) PCT Filed: Oct. 20, 2021
(86) PCT No.: PCT/US2021/055706

§ 371 Date: Mar. 28, 2024

(51) Int. Cl. B32B 27/08; B32B 7/12; B32B 27/32; B32B 33/00

(52) U.S. Cl. CPC B32B 27/08; B32B 7/12; B32B 27/32; B32B 33/00; B32B 2250/03; B32B 2250/242; B32B 2307/518; B32B 2307/72; B32B 2307/7376

(57) ABSTRACT

A packaging film includes a biaxially oriented polypropylene (BOPP) film including a thickness between 1 micron (μm) and 10 μm. The packaging film further includes a supporting film including polyethylene. The packaging film further includes a sealing film including polyethylene. The sealing film is located on a first exterior surface of the packaging film.

### TECHNICAL FIELD

The present application relates generally to a packaging film, and in particular to a packaging film that is recyclable, has an improved dimensional stability, and that allows easy opening by tearing.

### BACKGROUND

Various types of films used for packaging are known in the art. As a result of environmental and other concerns, there is a trend of using recyclable films for packaging. One example of such recyclable films includes a film having a mono-polyethylene structure (interchangeably referred to as “mono-PE film(s)”). However, such mono-PE films may not be suitable for wide use (especially for demanding applications) due to lower thermal-resistance, lower stiffness, and lower dimensional stability as compared to traditional multi-layer films, such as polyethylene terephthalate/polyethylene (PET/PE) and oriented polyamine/polyethylene (OPA/PE).

Easy opening or tearing functionality of packages formed by the recyclable films may be desirable to allow consumers to access at least a portion of packaged content without the use of cutting instruments, such as scissors, knives, etc.

Formulation of the recyclable films can be adjusted to provide the easy opening or tearing functionality to the recyclable films. However, addition of resins, such as ionomers and cyclic olefin copolymers, to the mono-PE films may be detrimental to the recycling of the mono-PE films in a polyethylene recycling stream.

Operations, such as laser scoring and mechanical perforation, to provide the easy opening or tearing functionality may be challenging in the mono-PE films. Further, such operations may affect other properties of the mono-PE films, such as barrier properties, and add extra steps to a process of manufacturing of the mono-PE films.

Using the mono-PE films with oriented polyethylene may help, however, orientation may not be sufficient to provide a controlled and smooth tearing and can be offset by a nature of polyethylene sealants used in the mono-PE films. For example, polyethylene sealants that provide superior drop resistance may not be easy to tear in a controlled manner.

Further, use of the mono-PE films with biaxially oriented polyethylene, which have low tear resistance in both directions, may not be preferred in some applications, such as for forming a pouch where easy linear tear in a machine direction (across a width of the pouch) is preferred, but high tear resistance is preferred in a cross direction (across a height of the pouch). Moreover, in such cases, the mono-PE films with biaxially oriented polyethylene may exhibit lower tear resistance in the cross direction as compared to the machine direction.

### SUMMARY

A packaging film has been developed which has improved heat and dimensional stability, and which allows easy opening or tearing in a machine direction. The packaging film may be recyclable, and may be used for forming stand-up pouches, gusseted pouches, pillow pouches, lidding, and the like.

One embodiment of the present disclosure is a packaging film. The packaging film includes a biaxially oriented polypropylene (BOPP) film including a thickness between 1 micron (μm) and 10 μm. The packaging film further includes a supporting film including polyethylene. The packaging film further includes a sealing film including polyethylene. The sealing film is located on a first exterior surface of the packaging film.

The packaging film may include a high polyethylene (PE) content (e.g., between 85% and 95%, by weight). Specifically, the supporting film and the sealing film include PE and form a significant portion of the packaging film. Therefore, the supporting film and the sealing film may form the bulk of the packaging film.

As the BOPP film is very thin (between 1 μm and 10 μm thick) relative to an overall thickness of the packaging film, the packaging film may have a low polypropylene (PP) content (e.g., less than 5%, by weight) and a limited amount of contaminating or undesirable elements in a polyethylene recycling stream. As a result, the packaging film may be recyclable in a polyethylene recycling stream.

The packaging film may provide improved heat and dimensional stability due to the thin BOPP film as compared to a conventional mono-PE structure. Further, the packaging film may have a lower tear resistance in a machine direction and a greater tear resistance in a cross direction due the thin BOPP film. In other words, the packaging film may exhibit easy opening or tearing in the machine direction while resisting opening or tearing in the cross direction due to the thin BOPP film.

The sealing film of the packaging film may be configured to provide desired functionalities and properties to the packaging film, such as, peelability, barrier properties, low seal initiation temperature, coefficient of friction requirements, etc. The sealing film may be further configured to provide specific features, such as toughness and drop resistance, to the packaging film.

Furthermore, the packaging film may be flexible and suitable for forming stand-up pouches, gusseted pouches, pillow pouches, lidding, and the like. The packaging film may also be suitable for forming packages with reclosable features.

In some embodiments, the supporting film includes a polyethylene content greater than 95%, by weight.

In some embodiments, the supporting film is a machine direction oriented polyethylene film.

In some embodiments, the supporting film is non-oriented.

In some embodiments, the supporting film includes high-density polyethylene.

In some embodiments, the supporting film is a polyethylene film having a density greater than 0.93 grams per cubic centimeter (g/cm³).

In some embodiments, the BOPP film is located on a second exterior surface of the packaging film.

In some embodiments, the BOPP film is located between the supporting film and the sealing film.

In some embodiments, the BOPP film includes a thickness between 1 μm and 6 μm.

In some embodiments, the packaging film includes a polyolefin content between 90% and 100%, by weight.

In some embodiments, the packaging film includes a polyethylene content between 85% and 95%, by weight.

In some embodiments, the sealing film includes a polyethylene content between 90% and 100%, by weight.

In some embodiments, the sealing film includes a thickness less than 70 μm.

In some embodiments, the sealing film includes a thickness between 50 μm and 70 μm.

In some embodiments, the sealing film includes an overall density between 0.88 g/cm³ and 0.93 g/cm³.

In some embodiments, the BOPP film includes homopolymer polypropylene.

In some embodiments, the BOPP film is attached to the supporting film by an adhesive layer.

In some embodiments, the packaging film further includes printed indicia.

In some embodiments, the packaging film is free of polyester film and metal foil.

In some embodiments, the packaging film is free of polyester film, polyamide and metal foil.

In some embodiments, the packaging film is free of polyester film, ethylene-vinyl alcohol copolymer, polyamide, and metal foil.

As discussed above, the packaging film may allow easy tearing or opening (e.g., controlled linear tear performance) in the machine direction, and may provide improved heat and dimensional stability compared to the conventional mono-PE structure. The sealing film of the packaging film may provide desired functionalities and properties, and may be configured to provide desired features, such as toughness and drop resistance. Moreover, the packaging film of the present disclosure may be recyclable in a mechanical recycling stream, including minimal contamination in a polyethylene recycling stream. Therefore, the packaging film of the present disclosure may be environmentally friendly and may promote a more favourable end-of-life scenario than traditional multi-layer laminates.

There are several aspects of the present subject matter which may be embodied separately or together. These aspects may be employed alone or in combination with other aspects of the subject matter described herein, and the description of these aspects together is not intended to preclude the use of these aspects separately or the claiming of such aspects separately or in different combinations.

### BRIEF DESCRIPTION OF THE DRAWINGS

The disclosure may be more completely understood in consideration of the following detailed description of various embodiments of the disclosure in connection with the accompanying drawings, in which:

FIG. 1A is a schematic cross-sectional view of a packaging film in accordance with an embodiment of the present disclosure;

FIG. 1B is a schematic top view of the packaging film in accordance with an embodiment of the present disclosure;

FIG. 2 is a schematic cross-sectional view of a packaging film in accordance with another embodiment of the present disclosure;

FIG. 3 is a graph depicting seal curves of various packaging films;

FIG. 4 is a graph depicting average secant moduli of various packaging films in a machine direction and in a cross direction; and

FIG. 5 is a graph depicting average tear resistances of various packaging films in a machine direction and in a cross direction.

The figures are not necessarily to scale. Like numbers used in the figures refer to like components. It will be understood, however, that the use of a number to refer to a component in a given figure is not intended to limit the component in another figure labeled with the same number.

### DETAILED DESCRIPTION

The present application describes a packaging film. The packaging film includes a biaxially oriented polypropylene (BOPP) film including a thickness between 1 micron (μm) and 10 μm. The packaging film further includes a supporting film including polyethylene. The packaging film further includes a sealing film including polyethylene. The sealing film is located on a first exterior surface of the packaging film.

The packaging film may include a high polyethylene (PE) content (e.g., between 85% and 95%, by weight). Specifically, the supporting film and the sealing film include PE and form a significant portion of the packaging film. Therefore, the supporting film and the sealing film may form the bulk of the packaging film.

As the BOPP film is very thin (between 1 μm and 10 μm thick) relative to an overall thickness the packaging film, the packaging film may have a low polypropylene (PP) content (e.g., less than 5%, by weight) and a limited amount of contaminating or undesirable elements in a polyethylene recycling stream. As a result, the packaging film may be recyclable in a mechanical polyethylene recycling stream.

The packaging film may provide an improved heat and dimensional stability due to the BOPP film as compared to a conventional mono-PE structure. Further, the packaging film may have a lower tear resistance in a machine direction and a greater tear resistance in a cross direction due the BOPP film. In other words, the packaging film may exhibit easy opening or tearing in the machine direction while resisting opening or tearing in the cross direction due to the BOPP film.

The sealing film of the packaging film may be configured to provide desired functionalities and properties to the packaging film, such as, peelability, barrier properties, low seal initiation temperature, coefficient of friction requirements, etc. The sealing film may be further configured to provide specific features, such as toughness and drop resistance, to the packaging film.

Furthermore, the packaging film may be flexible and suitable for forming stand-up pouches, gusseted pouches, pillow pouches, lidding, and the like. The packaging film may also be suitable for forming packages with reclosable features.

As used herein, the terms “first” and “second” are used as identifiers. Therefore, such terms should not be construed as limiting of this disclosure. The terms “first” and “second” when used in conjunction with a feature or an element can be interchanged throughout the embodiments of this disclosure.

As used herein, the term “film” is a material with a very high ratio of a length or a width to a thickness. A film has two major surfaces defined by a length and a width. Polymeric films typically have good flexibility and can be used for a wide variety of applications, including flexible packaging. Films may also be of thickness and/or material composition such that they are flexible, semi-rigid, or rigid. Films may be described as monolayer or multilayer.

As used herein, the term “layer” refers to a thickness of material that has a relatively consistent formula (i.e., a layer is homogeneous). Layers may be of any type of material including polymeric, cellulosic, and metallic, or a blend thereof. A given polymeric layer may consist of a single polymer-type or a blend of polymers and may be accompanied by additives. A given layer may be combined or connected to other layers to form films. A layer may be either partially or fully continuous as compared to adjacent layers or the film. A given layer may be partially or fully coextensive with adjacent layers. A layer may contain sub-layers.

As used herein, the terms “interior” and “exterior” refer to a location relative to the exposed major surfaces of a film. Interior films or layers comprise two major surfaces that are directly adjacent to another film or layer. Exterior films or layers comprise at least one major surface that is not directly adjacent to another film or layer. An exterior film or layer has a major surface that is exposed to the environment.

As used herein, the term “adhesive layer” refers to a layer which has a primary function of bonding two adjacent layers together. The adhesive layers may be positioned between two layers of a multilayer film to maintain the two layers in position relative to each other and prevent undesirable delamination. Unless otherwise indicated, an adhesive layer can have any suitable composition that provides a desired level of adhesion with the one or more surfaces in contact with the adhesive layer material.

As used herein, the term “sealing film” refers to a film, sheet, etc., involved in the sealing of the film, sheet, etc., to itself and/or to another layer of the same or another film, sheet, etc. Upon application of a sealing process (i.e. heat sealing), the film is connected to another component at the surface of the sealing film. The sealing film may be mono layer or multilayer.

As used herein, the term “barrier” refers to any material which controls a permeable element of a film, sheet, web, package, etc., against aggressive agents, and includes but is not limited to, oxygen barrier, moisture (e.g., water, humidity, etc.) barrier, chemical barrier, heat barrier, light barrier, and odor barrier. The term “barrier layer” refers to a layer of the film, sheet, web, package, etc., which controls such permeable element.

As used herein, the terms “heat seal”, “heat sealed”, “heat sealing”, “heat sealable”, and the like, refer to both a film layer which is heat sealable to itself or other thermoplastic film layer, and the formation of a fusion bond between two polymer surfaces by conventional indirect heating means. It will be appreciated that conventional indirect heating generates sufficient heat on at least one film contact surface for conduction to the contiguous film contact surface such that the formation of a bond interface therebetween is achieved without loss of the film integrity.

As used herein, the term “plastomer” refers to a polymer which combines qualities of elastomers and plastics, such as rubber-like properties with the processing ability of plastics. One example of a plastomer includes ethylene-alpha olefin copolymer.

As used herein, the term “metallocene” refers to a polymer that has been produced using a metallocene catalyst during the polymerization process.

As used herein, the terms “polyolefin” and “polyolefin-based polymers” refer to polyethylene homopolymers, polyethylene copolymers, polypropylene homopolymers, or polypropylene copolymers.

As used herein, the terms “polyethylene” and “polyethylene-based polymers” refers to polymers that include an ethylene linkage. Polyethylene-based polymers may be homopolymers, copolymers, or interpolymers. Polyethylene copolymers or interpolymers may include other types of polymers (i.e., non-polyethylene polymers). Polyethylenes may have functional groups incorporated by grafting or other means. Polyethylenes include, but are not limited to, low-density polyethylene (LDPE), linear low density polyethylene (LLDPE), medium-density polyethylene (MDPE), ultra-low density polyethylene (ULDPE), high-density polyethylene (HDPE), cyclic-olefin copolymers (COC), ethylene vinyl acetate copolymers (EVA), ethylene acrylic acid copolymers (EAA), ethylene methacrylic acid copolymers (EMAA), neutralized ethylene copolymers such as ionomer, and maleic anhydride grafted polyethylene (MAHgPE).

As used herein, the terms “polypropylene” and “polypropylene-based polymers” refers to polymers that are derived from monomers of propylene. Polypropylenes may be homopolymers, copolymers, or interpolymers. Polypropylene copolymers or interpolymers may include other types of polymers (i.e., non-polypropylene polymers). A propylene linkage can be represented by the general formula: [CH₂—CH(CH₃)]ₙ. Polypropylenes may have functional groups incorporated by grafting or other means. Polypropylenes include, but are not limited to, propylene-ethylene copolymers, ethylene-propylene copolymers, and maleic anhydride grafted polypropylenes (MAHgPP).

As used herein, the terms “ethylene/vinyl alcohol copolymer” and “EVOH” both refer to polymerized ethylene vinyl alcohol. Ethylene/vinyl alcohol copolymers include saponified (or hydrolyzed) ethylene/vinyl acrylate copolymers and refer to a vinyl alcohol copolymer having an ethylene comonomer prepared by, for example, hydrolysis of vinyl acrylate copolymers or by chemical reactions with vinyl alcohol. The degree of hydrolysis is, preferably, at least 50% and, more preferably, at least 85%. Preferably, ethylene/vinyl alcohol copolymers comprise from about 28-48 mole % ethylene, more preferably, from about 32-44 mole % ethylene, and, even more preferably, from about 38-44 mole % ethylene.

As used herein, the term “metal foil” refers to a layer of metal, such as an aluminum alloy. A metal foil has a thickness greater than about 6 micron and may be laminated to the other materials within a packaging film.

As used herein, the term “oriented” refers to a monolayer or multilayer film, sheet, or web which has been elongated in at least one of a machine direction or a transverse/cross direction. Non-limiting examples of such procedures include the single bubble blown film extrusion process and the slot case sheet extrusion process with subsequent stretching, for example, by tentering, to provide orientation. Another example of such procedure is the trapped bubble or double bubble process. (See, for example, U.S. Pat. Nos. 3,546,044 and 6,511,688, each of which is incorporated in its entirety in this application by this reference.) In the trapped bubble or double bubble process, an extruded primary tube leaving the tubular extrusion die is cooled, collapsed, and then oriented by reheating, reinflating to form a secondary bubble and recooling. Transverse direction orientation may be accomplished by inflation, radially expanding the heated film tube. Machine direction orientation may be accomplished by the use of nip rolls rotating at different speeds, pulling, or drawing the film tube in the machine direction. The combination of elongation at elevated temperature followed by cooling causes an alignment of the polymer chains to a more parallel configuration, thereby improving the mechanical properties of the film, sheet, web, package, or otherwise. Upon subsequent heating of an unrestrained, unannealed, oriented article to its orientation temperature, heat-shrinkage (as measured in accordance with American Society for Testing and Materials (ASTM) Test Method D2732, “Standard Test Method for Unrestrained Linear Thermal Shrinkage of Plastic Film and Sheeting,” which is incorporated in its entirety in this application by this reference) may be produced. Heat-shrinkage may be reduced if the oriented article is annealed or heat-set by heating to an elevated temperature, preferably to an elevated temperature which is above the glass transition temperature and below the crystalline melting point of the polymer comprising the article. This reheating/annealing/heat-setting step also provides a polymeric web of uniform flat width. The polymeric web may be annealed (i.e., heated to an elevated temperature) either in-line with (and subsequent to) or off-line from (in a separate process) the orientation process.

As used herein, the terms “unoriented” and “non-oriented” refer to a monolayer or multilayer film, sheet, or web that is substantially free of post-extrusion orientation.

As used herein, the term “printed indicia” refers to a marking, image, text, and/or symbol located on the surface of a film, sheet, or web. The printed indicia can be placed on the surface by any suitable means (e.g., ink printing, laser printing, etc.). The indicia can include, e.g., a printed message or instructions, list of ingredients (active and inactive), weight of product, manufacturer name and address, manufacturer trademark, etc.

As used herein, the term “seal initiation temperature” or “SIT” refers to a temperature at which a heat seal having a strength of at least 5.25 N/15 mm forms after the sealing operation. A strength of the heat seal is measured after the seal has cooled to ambient temperature and reached maximum strength. Seal initiation temperature may be measured by ASTM F1921.

As used herein, the term “secant modulus” refers to a measurement of a material's elasticity. The secant modulus may be measured via ASTM-D882 and may be referred to as “stiffness”. The secant modulus may be calculated using two points on a stress-strain curve to calculate the slope of the stress/strain. When using this method, the first point is always zero and the second is always a non-zero value.

As used herein, the term “high density polyethylene” or “HDPE” refers to both homopolymers of ethylene which have densities from about 0.960 gram per cubic centimeter (g/cm³) to about 0.970 g/cm³, and copolymers of ethylene and an alpha-olefin (usually 1-butene or 1-hexene) which have densities from about 0.940 g/cm³ to about 0.958 g/cm³. HDPE includes high molecular weight “polyethylenes.” The term “blown HDPE film” refers to a HDPE film manufactured by a blown film extrusion process.

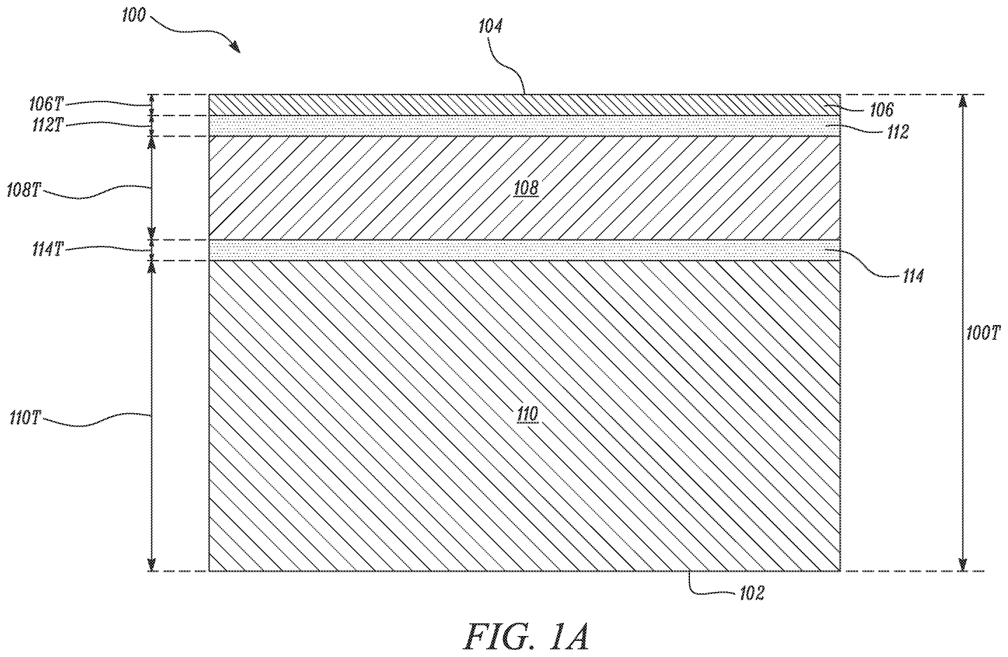

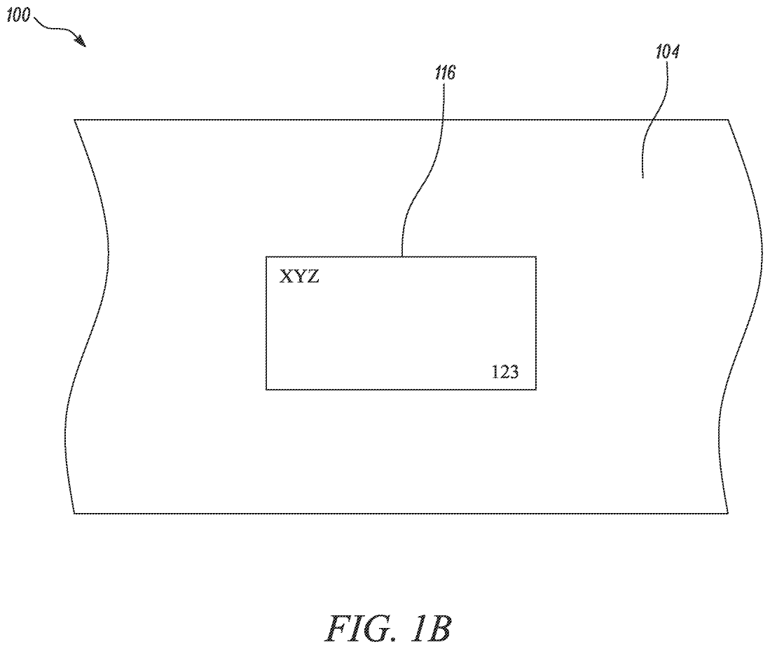

FIG. 1A shows a schematic cross-sectional view of a packaging film 100 in accordance with an embodiment of the present disclosure.

Packaging film 100 includes a biaxially oriented polypropylene (BOPP) film 106. BOPP film 106 includes biaxially oriented polypropylene-based polymers. Examples of the polypropylene-based polymers include polypropylene random copolymer (PPR or PP-R), polypropylene terpolymer, heterophasic propylene copolymer, rubber modified polypropylene copolymer, and the like.

In some embodiments, BOPP film 106 incudes homopolymer polypropylene. In some examples, BOPP film 106 may be composed of a mono-layer homopolymer polypropylene that is ultra-thin, transparent, non-heat sealable, and has a melting point of about 163 degrees Celsius (C).

BOPP film 106 includes a thickness 106T between 1 microns (μm) and 10 μm. In some embodiments, thickness 106T may be between 1 μm and 4 μm, between 4 μm and 7 μm, or between 7 μm and 10 μm. In some embodiments, thickness 106T is between 1 μm and 6 μm. In some embodiments, thickness 106T is about 3 μm. In some embodiments, thickness 106T is about 4 μm. BOPP film 106 may be very thin relative to an overall thickness of packaging film 100. Furthermore, BOPP film 106 may have a density between about 0.90 g/cm³ and 0.92 g/cm³. In some examples, BOPP film 106 may have a density of about 0.91 g/cm³.

Packaging film 100 further includes a supporting film 108 including polyethylene (PE). Supporting film 108 includes polyethylene-based polymers. Examples of the polyethylene-based polymers include polyethylene, low-density polyethylene (LDPE), linear low-density polyethylene (LLDPE), very low-density polyethylene (VLDPE), ultra low-density polyethylene (ULDPE), medium-density polyethylene (MDPE), ethylene copolymers, ethylene/vinyl acetate copolymers, ethylene/methyl acrylate copolymers, and the like.

In some embodiments, supporting film 108 includes high-density polyethylene (HDPE). In some embodiments, supporting film 108 is a polyethylene film including a density greater than 0.93 g/cm³. Supporting film 108 may include a density greater than 0.94 g/cm³, or greater than 0.95 g/cm³.

In some embodiments, supporting film 108 includes a polyethylene content greater than 95%, by weight. In some embodiments, supporting film 108 may include the polyethylene content greater than 96%, greater than 97%, greater than 98%, or greater than 99%, by weight. The polyethylene content of the supporting film 108 may include a single polyethylene or a blend of different polyethylene materials.

Supporting film 108 may be oriented or non-oriented, based upon application requirements. In some embodiments, supporting film 108 is oriented. Specifically, in some embodiments, supporting film 108 is a machine direction oriented polyethylene (MDOPE) film. However, in some other embodiments, supporting film 108 is non-oriented. In other words, in some embodiments, supporting film 108 is unoriented.

Supporting film 108 further includes a thickness 108T. In some embodiments, thickness 108T may be between 15 μm and 55 μm. In some embodiments, thickness 108T may be between 15 μm and 20 μm. In some embodiments, thickness 108T may be between 20 μm and 30 μm. In some embodiments, thickness 108T may be about 20 μm, about 25 μm, or about 50 μm.

Packaging film 100 further includes a sealing film 110 including polyethylene. Sealing film 110 includes polyethylene-based polymers. Examples of the polyethylene-based polymers include polyethylene, low-density polyethylene (LDPE), linear low-density polyethylene (LLDPE), very low-density polyethylene (VLDPE), ultra low-density polyethylene (ULDPE), medium-density polyethylene (MDPE), high-density polyethylene (HDPE), ethylene copolymers, ethylene/vinyl acetate copolymers, ethylene/methyl acrylate copolymers, and the like.

In some embodiments, sealing film 110 includes a polyethylene content between 90% and 100%, by weight. In some embodiments, sealing film 110 may include a polyethylene content between 90% and 92%, or between 92% and 94%, or between 94% and 96%, or between 96% and 98%, or between 98% and 100%, by weight.

In some embodiments, sealing film 110 includes an overall density between 0.88 g/cm³ and 0.93 g/cm³. For example, sealing film 110 may include an overall density of about 0.88 g/cm³, or about 0.89 g/cm³, or about 0.90 g/cm³, or about 0.91 g/cm³, or about 0.92 g/cm³, or about 0.93 g/cm³.

Sealing film 110 further includes a thickness 110T. In some embodiments, thickness 110T is less than 70 μm. In some embodiments, thickness 110T is between 50 μm and 70 μm. In some embodiments, thickness 110T is about 60 μm.

Sealing film 110 may seal to itself. Sealing film 110 may be heat-sealable. Further, sealing film 110 may provide desired functionalities and properties to packaging film 100. For example, sealing film 110 may provide desired peelability and/or sealing properties. In another example, sealing film 110 may provide desirable barrier properties or non-barrier properties. In yet another example, sealing film 110 may provide a desired seal initiation temperature (SIT), based on application requirements. Sealing film 110 may further be configured to provide desired features, such as toughness and drop resistance.

Packaging film 100 further includes a first exterior surface 102 and a second exterior surface 104 opposite to first exterior surface 102. Sealing film 110 is located on first exterior surface 102 of packaging film 100. In other words, sealing film 110 forms first exterior surface 102 of packaging film 100. In the illustrated embodiment of FIG. 1, BOPP film 106 is located on second exterior surface 104 of packaging film 100. In other words, BOPP film 106 forms second exterior surface 104 of packaging film 100. Further, in the illustrated embodiment of FIG. 1, supporting film 108 is located between BOPP film 106 and sealing film 110.

In the illustrated embodiment of FIG. 1, packaging film 100 further includes a first adhesive layer 112. First adhesive layer 112 may include a thickness 112T between 0.5 μm and 5 μm. In the illustrated embodiment of FIG. 1, BOPP film 106 is attached to supporting film 108 by an adhesive layer, i.e., first adhesive layer 112. In other words, first adhesive layer 112 attaches BOPP film 106 to supporting film 108.

In the illustrated embodiment of FIG. 1, packaging film 100 further includes a second adhesive layer 114. Second adhesive layer 114 may include a thickness 114T between 0.5 μm and 5 μm. In the illustrated embodiment of FIG. 1, sealing film 110 is attached to supporting film 108 by second adhesive layer 114.

In some embodiments, each of first and second adhesive layers 112, 114 may have a weight of about 4 grams per square meter (g/m²). Each of first and second adhesive layers 112, 114 may include any suitable adhesive, based on application requirements. For example, each of first and second adhesive layers 112, 114 may include an adhesive selected from the group consisting of polyurethane dispersions, acrylic emulsions, water-based polyvinyl alcohol, vinyl acetate copolymers, modified polyolefins, polyesters, synthetic or natural rubber, solvent-based acrylics, one or two component solvent-based polyurethanes, and radiation-curable adhesives. In some embodiments, first and second adhesive layers 112, 114 may include a solvent-based polyurethane adhesive.

In some embodiments, packaging film 100 includes a polyolefin content between 90% and 100%, by weight. In some embodiments, packaging film 100 includes a polyethylene content between 85% and 95%, by weight. Further, in some embodiments, packaging film 100 may include a polypropylene content less than 5%, by weight. In some embodiments, packaging film 100 may include a polypropylene content between 2% and 5%, by weight.

In some embodiments, packaging film 100 is free of polyester film and metal foil. In some embodiments, packaging film 100 is free of polyester film, polyamide and metal foil. In some embodiments, packaging film 100 is free of polyester film, ethylene-vinyl alcohol copolymer, polyamide, and metal foil.

Packaging film 100 further includes a thickness 100T. In some embodiments, thickness 100T is between 80 μm and 120 μm. In some embodiments, thickness 100T is between 80 μm and 85 μm. In some embodiments, thickness 100T is between 85 μm and 90 μm. In some embodiments, thickness 100T is between 90 μm and 95 μm, between 95 μm and 100 μm, between 100 μm and 105 μm, between 105 μm and 110 μm, between 110 μm and 115 μm, or between 115 μm and 120 μm. In some embodiments, thickness 100T is about 84 μm, about 88 μm, or about 114 μm.

In some embodiments, thickness 106T of BOPP film 106 may be between 0.5% to 15% of thickness 100T of packaging film 100. In some embodiments, thickness 106T of BOPP film 106 may be at most 1%, at most 2%, at most 5%, at most 8%, at most 10%, or at most 12% of thickness 100T of packaging film 100.

FIG. 1B illustrates a schematic top view of packaging film 100. Referring to FIGS. 1A and 1B, packaging film 100 further includes printed indicia 116. Printed indicia 116 may be formed by any suitable printing process, such as offset printing, flexography, rotogravure, digital printing process, and the like. In some embodiments, printed indicia 116 may be printed on a surface of BOPP film 106. In some embodiments, printed indicia 116 may be printed on a surface of supporting film 108. In some embodiments, printed indicia 116 may be deposited directly on second exterior surface 104 of packaging film 100. In some embodiments, printed indicia 116 may be located between the BOPP film 106 and the supporting film 108. Printed indicia 116 may be located between any two films comprised in the packaging film 100, thus not exposed on either the first or second exterior surface 102, 104. Printed indicia 116 may include any suitable combination of alphanumeric characters, symbols, visual or pictorial elements, colors, and the like. Printed indicia may be visible by viewing the first exterior surface 102 and/or the second exterior surface 104 of the packaging film 100.

Packaging film 100 may be used to form a package (not shown) that can contain a product (not shown). The package may be, for example, a stand-up pouch, a gusseted pouch, a pillow pouch, a lid and cup (the packaging film 100 may be the lid), and the like. The package formed by packaging film 100 may also be suitable to be formed or provided with reclosable features.

The package may be easily tearable (i.e. tearable by manual force) in a machine direction while resisting tearing in a cross direction. The package may include one or more pre-cuts to facilitate or initiate tearing in the machine direction. The package may exhibit improved heat and dimensional stability as compared to packages formed by conventional mono-PE structures, due to the BOPP film 106 of the packaging film 100.

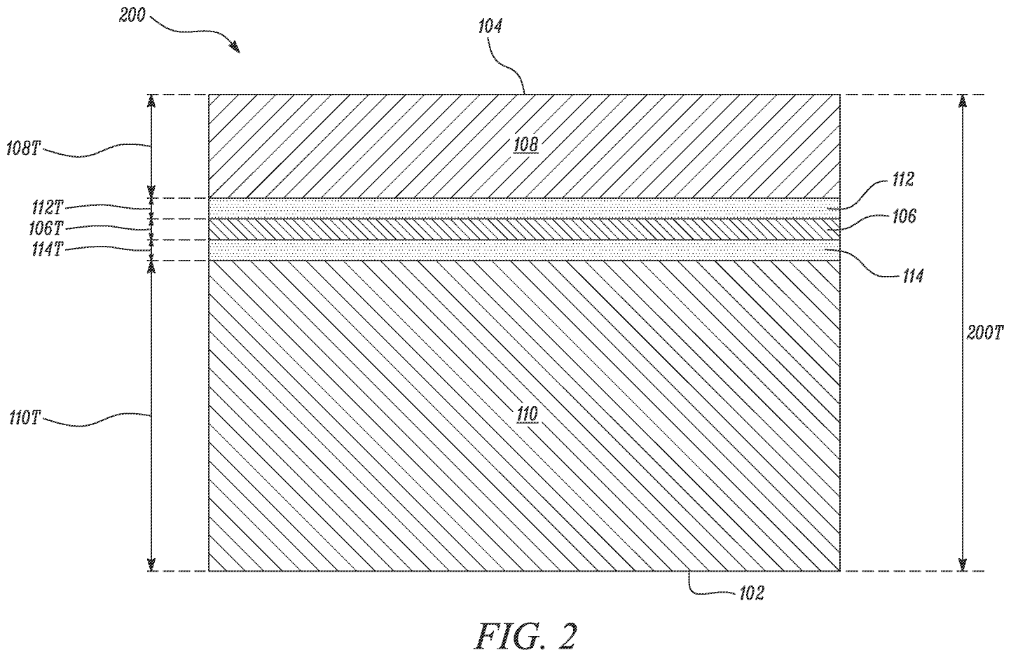

FIG. 2 illustrates a schematic cross-sectional view of a packaging film 200 in accordance with another embodiment of the present disclosure.

Packaging film 200 is similar to packaging film 100 of FIG. 1A, with like elements designated by like numbers. However, packaging film 200 has a different configuration of BOPP film 106 and supporting film 108 as compared to packaging film 100.

Specifically, in the illustrated embodiment of FIG. 2, BOPP film 106 is located between supporting film 108 and sealing film 110. Sealing film 110 is located on first exterior surface 102 of packaging film 100. In other words, sealing film 110 forms first exterior surface 102 of packaging film 100. Further, in the illustrated embodiment of FIG. 2, supporting film 108 is located on second exterior surface 104 of packaging film 200. In other words, supporting film 108 forms second exterior surface 104 of packaging film 200. Moreover, in the illustrated embodiment of FIG. 2, BOPP film 106 is attached to supporting film 108 by first adhesive layer 112 and sealing film 110 is attached to BOPP film 106 by second adhesive layer 114.

Packaging film 200 includes a thickness 200T. In some embodiments, thickness 200T is between 80 μm and 120 μm. In some embodiments, thickness 200T is between 80 μm and 85 μm. In some embodiments, thickness 200T is between 85 μm and 90 μm. In some embodiments, thickness 200T is between 90 μm and 95 μm, between 95 μm and 100 μm, between 100 μm and 105 μm, between 105 μm and 110 μm, between 110 μm and 115 μm, or between 115 μm and 120 μm. In some embodiments, thickness 200T is about 84 μm, about 88 μm, or about 114 μm.

### EXAMPLES

The following illustrative examples are merely meant to exemplify the present invention, but they are not intended to limit or otherwise define the scope of the present disclosure.

### Example 1

Example 1 is a comparative example which is a conventional packaging film having a mono-PE structure. The conventional packaging film of Example 1 has a structure of MDOPE/Adhesive/PE.

The MDOPE film of the Example 1 film had a thickness of 20 microns, a weight of 18.84 g/m², and a density of 0.942 g/cm³. The adhesive layer of the Example 1 film had a weight of 4 g/m². The PE film of the Example 1 film had a thickness of 60 microns, a weight of 54.48 g/m², and a density of 0.908 g/cm³. The PE film of the Example 1 film was a low SIT PE film free of HDPE.

The Example 1 film had a thickness of 84 microns and a weight of 77.32 g/m². The Example 1 film included an overall polyolefin content of 94.83%, by weight. The Example 1 film included a polyethylene content of 94.83%, by weight, and a polypropylene content of 0%, by weight.

### Example 2

Example 2 film was produced and is exemplary of the inventive packaging film. Referring to FIG. 1A, the Example 2 film included BOPP film 106 having thickness 106T of 4 microns, a weight of 3.64 g/m², and a density of 0.91 g/cm³.

The Example 2 film further included supporting film 108 having thickness 108T of 20 microns, a weight of 18.84 g/m², and a density of 0.942 g/cm³. Supporting film 108 of the Example 2 film was an MDOPE film.

The Example 2 film further included sealing film 110 having thickness 110T of 60 microns, a weight of 54.48 g/m², and a density of 0.908 g/cm³. Sealing film 110 of the Example 2 film was a low SIT PE film composed of a blend of LDPE, plastomer, and LLDPE copolymer. Further, sealing film 110 of the Example 2 film was free of HDPE.

In the Example 2 film, supporting film 108 was located between BOPP film 106 and sealing film 110.

The Example 2 film further included first adhesive layer 112 that attached BOPP film 106 to supporting film 108. First adhesive layer 112 of the Example 2 film had a weight of 4 g/m². The Example 2 film further included second adhesive layer 114 that attached sealing film 110 to supporting film 108. Second adhesive layer 114 of the Example 2 film had a weight of 4 g/m².

The Example 2 film had a thickness of 92 microns and a weight of 84.96 g/m². The Example 2 film included a polyolefin content of 90.58%, by weight. The Example 2 film included a polyethylene content of 86.30%, by weight, and a polypropylene content of 4.28%, by weight.

### Example 3

Example 3 film was produced and is exemplary of the inventive packaging film. Referring to FIG. 2, the Example 3 film included supporting film 108 having thickness 108T of 20 microns, a weight of 18.84 g/m², and a density of 0.942 g/cm³. Supporting film 108 of the Example 3 film was an MDOPE film.

The Example 3 film further included BOPP film 106 having thickness 106T of 4 microns, a weight of 3.64 g/m², and a density of 0.91 g/cm³.

The Example 3 film further included sealing film 110 having thickness 110T of 60 microns, a weight of 54.48 g/m², and a density of 0.908 g/cm³. Sealing film 110 was a low SIT PE film free of HDPE.

In the Example 3 film, BOPP film 106 was located between supporting film 108 and sealing film 110.

The Example 3 film further included first adhesive layer 112 that attached BOPP film 106 to supporting film 108. First adhesive layer 112 of the Example 3 film had a weight of 4 g/m². The Example 3 film further included second adhesive layer 114 that attached sealing film 110 to BOPP film 106. Second adhesive layer 114 of the Example 3 film had a weight of 4 g/m².

The Example 3 film had a thickness of 92 microns and a weight of 84.96 g/m². The Example 3 film included a polyolefin content of 90.58%, by weight. The Example 3 film included a polyethylene content of 86.30%, by weight, and a polypropylene content of 4.28%, by weight.

### Example 4

Example 4 film was produced and is exemplary of the inventive packaging film. Referring to FIG. 1A, the Example 4 film included BOPP film 106 having thickness 106T of 3 microns, a weight of 2.73 g/m², and a density of 0.91 g/cm³.

The Example 4 film further included supporting film 108 having thickness 108T of 25 microns, a weight of 23.55 g/m², and a density of 0.942 g/cm³. Supporting film 108 of the Example 4 film was an MDOPE film.

The Example 4 film further included sealing film 110 having thickness 110T of 60 microns, a weight of 54.48 g/m², and a density of 0.908 g/cm³. Sealing film 110 of the Example 4 film was a low SIT PE film free of HDPE.

In the Example 4 film, supporting film 108 was located between BOPP film 106 and sealing film 110.

The Example 4 film further included first adhesive layer 112 that attached BOPP film 106 to supporting film 108. First adhesive layer 112 of the Example 4 film had a weight of 4 g/m². The Example 4 film further included second adhesive layer 114 that attached sealing film 110 to supporting film 108. Second adhesive layer 114 of the Example 4 film had a weight of 4 g/m².

The Example 4 film had a thickness of 96 microns and a weight of 88.76 g/m². The Example 4 film included a polyolefin content of 90.99%, by weight. The Example 4 film included a polyethylene content of 87.91%, by weight, and a polypropylene content of 3.08%, by weight.

### Example 5

Example 5 film was produced as a comparative example. Referring to FIG. 1A, the Example 5 film included BOPP film 106 having thickness 106T of 4 microns, a weight of 3.64 g/m², and a density of 0.91 g/cm³.

The Example 5 film further included supporting film 108 having thickness 108T of 25 microns, a weight of 23.55 g/m², and a density of 0.942 g/cm³. Supporting film 108 of the Example 5 film was an MDOPE film.

The Example 5 film further included sealing film 110 having thickness 110T of 80 microns, a weight of 72.64 g/m², and a density of 0.908 g/cm³. Sealing film 110 was a low SIT PE film free of HDPE. The sealing film 110 of Example 5 had the same composition as the sealing film 110 of Example 4.

In the Example 5 film, supporting film 108 was located between BOPP film 106 and sealing film 110.

The Example 5 film further included first adhesive layer 112 that attached BOPP film 106 to supporting film 108. First adhesive layer 112 of the Example 5 film had a weight of 4 g/m². The Example 5 film further included second adhesive layer 114 that attached sealing film 110 to supporting film 108. Second adhesive layer 114 of the Example 5 film had a weight of 4 g/m².

The Example 5 film had a thickness of 117 microns and a weight of 107.83 g/m². The Example 5 film included a polyolefin content of 92.58%, by weight. The Example 5 film included a polyethylene content of 89.21%, by weight, and a polypropylene content of 3.38%, by weight.

### Example 6

Example 6 film was produced as a comparative example. Referring to FIG. 1A, the Example 6 film included BOPP film 106 having thickness 106T of 4 microns, a weight of 3.64 g/m², and a density of 0.91 g/cm³.

The Example 6 film further included supporting film 108 having thickness 108T of 25 microns, a weight of 23.55 g/m², and a density of 0.942 g/cm³. Supporting film 108 of the Example 6 film was an MDOPE film.

The Example 6 film further included sealing film 110 having thickness 110T of 100 microns, a weight of 90.8 g/m², and a density of 0.908 g/cm³. Sealing film 110 of the Example 6 film was a low SIT PE film free of HDPE. The sealing film 110 of Example 6 had the same composition as the sealing film 110 of Example 4.

In the Example 6 film, supporting film 108 was located between BOPP film 106 and sealing film 110.

The Example 6 film further included first adhesive layer 112 that attached BOPP film 106 to supporting film 108. First adhesive layer 112 of the Example 6 film had a weight of 4 g/m². The Example 6 film further included second adhesive layer 114 that attached sealing film 110 to supporting film 108. Second adhesive layer 114 of the Example 6 film had a weight of 4 g/m².

The Example 6 film had a thickness of 137 microns and a weight of 125.99 g/m². The Example 6 film included a polyolefin content of 93.65%, by weight. The Example 6 film included a polyethylene content of 90.76%, by weight, and a polypropylene content of 2.89%, by weight.

### Example 7

Example 7 film was produced and is exemplary of the inventive packaging film. Referring to FIG. 1A, the Example 7 film included BOPP film 106 having thickness 106T of 4 microns, a weight of 3.64 g/m², and a density of 0.91 g/cm³.

The Example 7 film further included supporting film 108 having thickness 108T of 50 microns, a weight of 47.9 g/m², and a density of 0.958 g/cm³. Supporting film 108 of the Example 7 film was a blown HDPE film.

The Example 7 film further included sealing film 110 having thickness 110T of 60 microns, a weight of 54.48 g/m², and a density of 0.908 g/cm³. Sealing film 110 of the Example 7 film was a low SIT PE film free of HDPE.

In the Example 7 film, supporting film 108 was located between BOPP film 106 and sealing film 110.

The Example 7 film further included first adhesive layer 112 that attached BOPP film 106 to supporting film 108. First adhesive layer 112 of the Example 7 film had a weight of 4 g/m². The Example 7 film further included second adhesive layer 114 that attached sealing film 110 to supporting film 108. Second adhesive layer 114 of the Example 7 film had a weight of 4 g/m².

The Example 7 film had a thickness of 122 microns and a weight of 114.02 g/m². The Example 7 film included a polyolefin content of 92.98%, by weight. The Example 7 film included a polyethylene content of 89.79%, by weight, and a polypropylene content of 3.19%, by weight.

### Example 8

Example 8 film was produced as a comparative example. The Example 8 film included a BOPP film having a thickness of 4 microns, a weight of 3.64 g/m², and a density of 0.91 g/cm³.

The Example 8 film further included a PE film (a low SIT film) free of HDPE having a thickness of 100 microns, a weight of 90.8 g/m², and a density of 0.908 g/cm³.

The Example 8 film further included an adhesive layer that attached the BOPP film to the PE film free of HDPE. The adhesive layer of the Example 8 film had a weight of 4 g/m².

The Example 8 film had a thickness of 108 microns and a weight of 98.44 g/m². The Example 8 film included a polyolefin content of 95.94%, by weight. The Example 8 film included a polyethylene content of 92.24%, by weight, and a polypropylene content of 3.70%, by weight.

### Example 9

Example 9 film was produced as a comparative example. The Example 9 film included a BOPP film having a thickness of 4 microns, a weight of 3.64 g/m², and a density of 0.91 g/cm³.

The Example 9 film further included a PE film (a low SIT film) including HDPE and having a thickness of 100 microns, a weight of 92.7 g/m², and a density of 0.927 g/cm³.

The Example 9 film further included an adhesive layer that attached the BOPP film to the PE film including HDPE. The adhesive layer of the Example 9 film had a weight of 4 g/m².

The Example 9 film had a thickness of 108 microns and a weight of 100.34 g/m². The Example 9 film included a polyolefin content of 96.01%, by weight. The Example 9 film included a polyethylene content of 92.39%, by weight, and a polypropylene content of 3.63%, by weight.

### Experimental Results

Experiments were conducted on the produced packaging films to determine their seal, tensile, and tear properties. Experimental results corresponding to Examples 1-9 are provided below.

### Experiment 1

Referring to Examples 1-3, respective sealing films 110 of the Example 2 film and the Example 3 film, and the PE film of the Example 1 film were sealed to themselves via two heated seal bars at a pressure of 400 N/20 cm² for 0.5 seconds at different temperatures to form seals. American Society for Testing and Materials (ASTM) method F88 was used to measure a seal strength of the seals formed at the different sealing temperatures. A tensile testing machine having a load cell of 1000 N was used to generate the seal curve data of Experiment 1.

The Example 2 film, the Example 3 film, and the Example 1 film were pulled across respective seals at a pulling velocity of 300 millimeters (mm)/minute using the tensile testing machine to determine the seal strength of the respective seals. The seal strength of the respective seals at the different temperatures was determined and plotted on a graph described hereinafter.

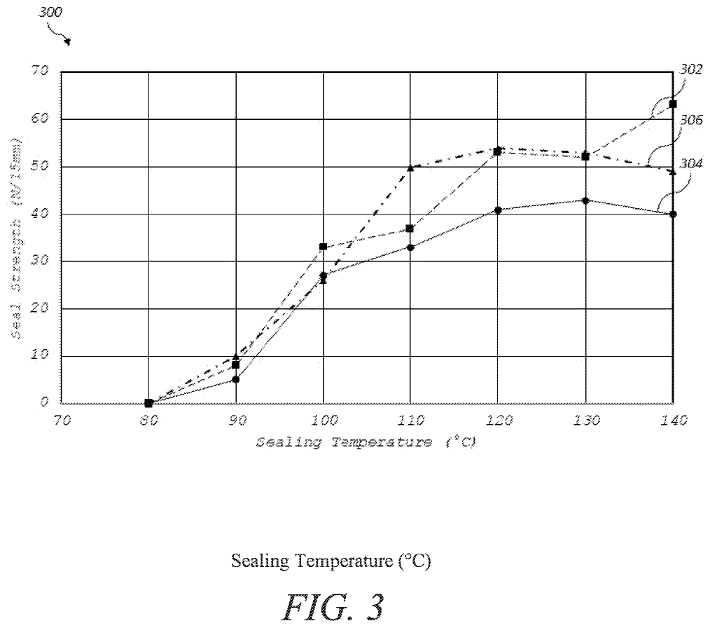

FIG. 3 shows a graph 300 depicting seal curves of the conventional packaging film of Example 1, the packaging film of Example 2, and the packaging film of Example 3. Graph 300 depicts seal strength (in N/15 mm) on the ordinate (Y-axis) and sealing temperature (in ° C.) on the abscissa (X-axis).

Graph 300 includes a first curve 302 (shown by dashed lines) depicting a seal curve of the Example 2 film. The seal strength of the seals formed at the different temperatures is shown by a solid square. As depicted by first curve 302, the seal strength of the seals of the Example 2 film was 0 N/15 mm at 80° C., about 8 N/15 mm at 90° C., about 33 N/15 mm at 100° C., about 37 N/15 mm at 110° C., about 53 N/15 mm at 120° C., about 52 N/15 mm at 130° C., and about 63 N/15 mm at 140° C.

Graph 300 further includes a second curve 304 (shown by solid lines) depicting a seal curve of the Example 3 film. The seal strength of the seals formed at the different temperatures is shown by a solid circle. As depicted by second curve 304, the seal strength of the seals of the Example 3 film was 0 N/15 mm at 80° C., about 5 N/15 mm at 90° C., about 27 N/15 mm at 100° C., about 33 N/15 mm at 110° C., about 41 N/15 mm at 120° C., about 43 N/15 mm at 130° C., and about 40 N/15 mm at 140° C.

Graph 300 further includes a third curve 306 (shown by dashed-dot lines) depicting a seal curve of the Example 1 film. The seal strength of the seals formed at the different temperatures is shown by a solid triangle. As depicted by third curve 306, the seal strength of the seals of the Example 1 film was 0 N/15 mm at 80° C., about 10 N/15 mm at 90° C., about 26 N/15 mm at 100° C., about 50 N/15 mm at 110° C., about 54 N/15 mm at 120° C., about 53 N/15 mm at 130° C., and about 49 N/15 mm at 140° C.

First curve 302, second curve 304, and third curve 306 show that the Example 2 film and the Example 3 film had a similar seal initiation temperature (i.e., 85-90° C.) as the Example 1 film. Further, the three films (comparative Example 1, inventive Example 2 and inventive Example 3) display similar sealing characteristics, indicating that there is limited influence on seal performance due to the addition of the thin BOPP film.

### Experiment 2

Referring to Examples 1-3, ASTM method D882 was used to determine secant moduli of the Example 2 film, the Example 3 film, and the Example 1 film. A tensile testing machine having a load cell of 250 N was used to collect the data for Experiment 2.

The Example 2 film, the Example 3 film, and the Example 1 film were pulled along a machine direction (MD) and a cross direction (CD) using the tensile testing machine at a pulling velocity of 25 mm/minute.

Stress-strain curves of each of the Example 2 film, the Example 3 film, and the Example 1 film were determined. Secant moduli of each of the Example 2 film, the Example 3 film, and the Example 1 film in the MD and in the CD was calculated at 1% tensile strain. The experiment was repeated five times, and average secant moduli of each of the Example 2 film, the Example 3 film, and the Example 1 film in the MD and in the CD were calculated and provided in Table 1 below.

TABLE 1
Secant Modulus at 1% elongation (N/mm²)

| | Machine Direction | Cross Direction |
|---|---|---|
| | (MD) | (CD) |
| | m_{avg} | c_{avg} |
| Example 1Film | 452 | 487 |
| Example 2 Film | 527 | 619 |
| Example 3 Film | 536 | 630 |

In Table 1, the average of the five secant moduli is referred to by m_{avg}. An average of the five secant moduli is referred to by c_{avg}.

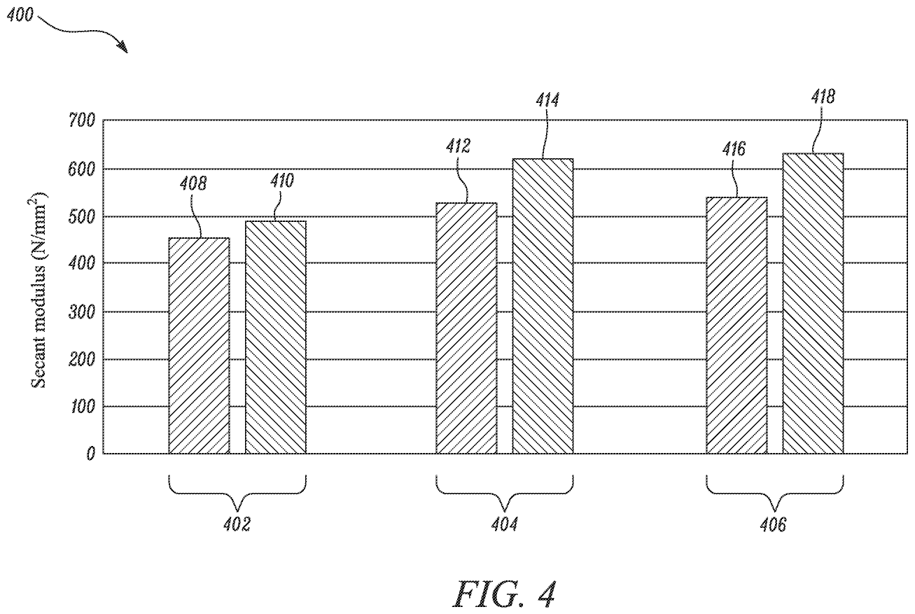

FIG. 4 shows a graph 400 depicting average secant moduli at 1% elongation of the Example 2 film, the Example 3 film, and the Example 1 film in the MD and in the CD. In graph 400, the Example 1 film is represented by a reference number 402, the Example 2 film is represented by a reference number 404, and the Example 3 film is represented by a reference number 406.

Graph 400 depicts secant modulus (in Newton per millimeter square or N/mm²) on the ordinate (Y-axis), and the reference numbers 402, 404, 406 representing different packaging films on the abscissa (X-axis).

Graph 400 includes a first bar 408 and a second bar 410 depicting the average secant moduli at 1% elongation of the Example 1 film in the MD and in the CD, respectively. As depicted by first bar 408 and Table 1, the average secant modulus at 1% elongation of the Example 1 film in the MD was 452 N/mm². As depicted by second bar 410 and Table 1, the average secant modulus at 1% elongation of the Example 1 film in the CD was 487 N/mm².

Graph 400 further includes a third bar 412 and a fourth bar 414 depicting the average secant moduli at 1% elongation of the Example 2 film in the MD and in the CD, respectively. As depicted by third bar 412 and Table 1, the average secant modulus at 1% elongation of the Example 2 film in the MD was 527 N/mm². As depicted by fourth bar 414 and Table 1, the average secant modulus at 1% elongation of the Example 2 film in the CD was 619 N/mm².

Graph 400 further includes a fifth bar 416 and a sixth bar 418 depicting the average secant moduli at 1% elongation of the Example 3 film in the MD and in the CD, respectively. As depicted by fifth bar 416 and Table 1, the average secant modulus at 1% elongation of the Example 3 film in the MD was 536 N/mm². As depicted by sixth bar 418 and Table 1, the average secant modulus at 1% elongation of the Example 3 film in the CD was 630 N/mm².

The average secant moduli at 1% elongation of the first and Example 3 films in the MD are greater than the average secant modulus at 1% elongation of the Example 1 film in the MD. Further, the average secant moduli at 1% elongation of the first and Example 3 films in the CD are significantly greater than the average secant modulus at 1% elongation of the Example 1 film in the CD.

Further, a difference between the average secant moduli at 1% elongation of the Example 1 film in the MD and in the CD was 35 N/mm². However, a difference between the average secant moduli at 1% elongation of the Example 2 film in the MD and in the CD was 92 N/mm², and a difference between the average secant moduli at 1% elongation of the Example 3 film in the MD and in the CD was 94 N/mm².

It was determined that the average secant moduli at 1% elongation of the Example 2 and Example 3 films in the MD increased as compared to the Example 1 film due to BOPP film 106 (shown in FIG. 1A) in the Example 2 and Example 3 films. Furthermore, the average secant moduli at 1% elongation of the Example 2 and Example 3 films in the CD significantly increased as compared to the Example 1 film due to BOPP film 106 in the Example 2 and Example 3 films. Consequently, the dimensional stability of the Example 2 and Example 3 films was improved as compared to the Example 1 film due to BOPP film 106 in the Example 2 and Example 3 films.

### Experiment 3

Referring to Examples 1-9, ASTM method D1922 was used to determine tear resistances of the Example 1 film, the Example 2 film, the Example 3 film, the Example 4 film, the Example 5 film, the Example 6 film, the Example 7 film, the Example 8 film, the Example 9 film.

Five samples were cut from each of the Example 1 film, the Example 2 film, the Example 3 film, the Example 4 film, the Example 5 film, the Example 6 film, the Example 7 film, the Example 8 film, the Example 9 film.

A sample was positioned in a tearing tester and clamped in place. A pendulum of the tearing tester was released to propagate a pre-cut slit. An energy loss of the pendulum was used to calculate an average tearing resistance of the sample. The experiment was repeated for other samples in a similar manner.

Tear resistances of each sample of the Example 2 film, the Example 3 film, and the Example 1 film in the MD and in the CD are provided in Tables 2 and 3 below, along with qualitative tearing behavior observations. The values provided are an average of five measurements.

TABLE 2
Machine Direction Tear Resistance (mN)

| Machine Direction | m_{avg} | Tear Quality |
|---|---|---|
| Example 1 Film | 6114 | Not straight, zippery tear, |
| | | and delamination |
| Example 2 Film | 790 | Straight and smooth tear |
| Example 3 Film | 816 | Straight and smooth tear |

TABLE 3
Cross Direction Tear Resistance (mN)

| Cross Direction | c_{avg} | Tear Quality |
|---|---|---|
| Example 1 Film | 1378 | Straight and zippery tear |
| Example 2 Film | 4940 | Not straight, zippery tear, |
| | | and delamination |
| Example 3 Film | 2309 | Not straight, zippery tear, |
| | | and delamination |

In Table 2, the average of the measured tear resistances is referred to by m_{avg}. Further, in Table 3, the average of the measured tear resistances is referred to by c_{avg}. The results were plotted on a graph described hereinafter.

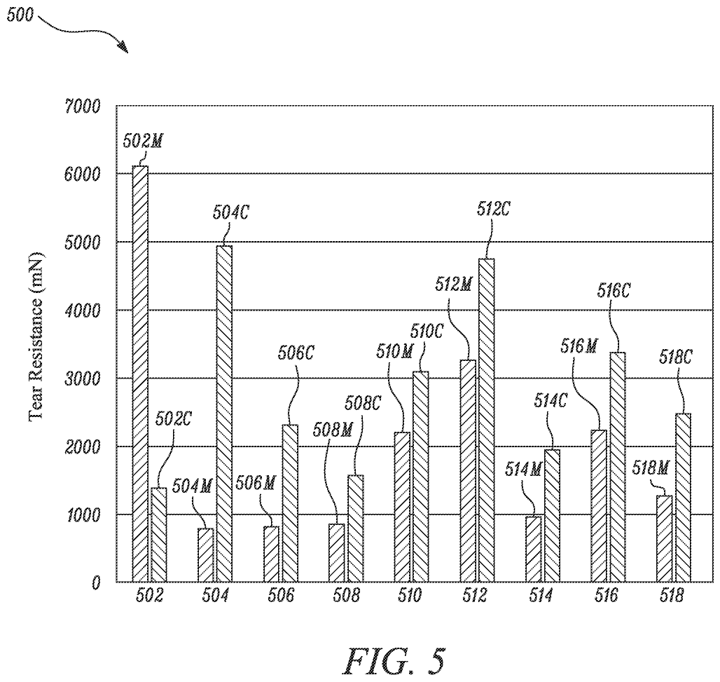

FIG. 5 shows a graph 500 depicting tear resistance (in milli Newton or mN) on the ordinate (Y-axis), and reference numbers corresponding to the different packaging films on the abscissa (X-axis).

Referring to Examples 1-3, graph 500 depicts the average tear resistances of each of the Example 1 film, the Example 2 film, and the Example 3 film in the MD and in the CD. In graph 500, the Example 1 film is represented by a reference number 502, Example 2 film is represented by a reference number 504, and the Example 3 film is represented by a reference number 506.

Graph 500 includes a first bar 502M and a second bar 502C depicting the average tear resistances (shown in Tables 2 and 3) of the Example 1 film in the MD and in the CD, respectively. As depicted by first bar 502M, the average tear resistance of the Example 1 film in the MD was 6114 mN. As depicted by second bar 502C, the average tear resistance of the Example 1 film in CD was 1378 mN.

Graph 500 further includes a third bar 504M and a fourth bar 504C depicting the average tear resistances (shown in Tables 2 and 3) of the Example 2 film in the MD and in the CD, respectively. As depicted by third bar 504M, the average tear resistance of the Example 2 film in the MD was 790 mN. As depicted by fourth bar 504C, the average tear resistance of the Example 2 film in the CD was 4940 mN.

Graph 500 further includes a fifth bar 506M and a sixth bar 506C depicting the average tear resistances (shown in Tables 2 and 3) of the Example 3 film in the MD and in the CD, respectively. As depicted by fifth bar 506M, the average tear resistance of the Example 3 film in the MD was 816 mN. As depicted by sixth bar 506C, the average tear resistance of the Example 3 film in the CD was 2309 mN.

The Example 1 film had a much greater average tear resistance (i.e., 6114 mN) in the MD than in the CD (i.e., 1378 mN). Further, the Example 1 film exhibited uneven or irregular tearing in both the MD and the CD. However, the Example 2 and Example 3 films had a relatively low average tear resistance (i.e., 790 mN and 816 mN, respectively) in the MD and a high average tear resistance (i.e., 4940 mN and 2309 mN, respectively) in the CD. Further, the Example 2 and Example 3 films exhibited smooth and straight tear in the MD.

It was concluded that the first and Example 3 films allowed a smooth linear tear in the MD while enhancing the average tear resistance in the CD compared to the Example 1 film due to BOPP film 106 in the first and Example 3 films.

Referring to Examples 4-6, graph 500 further depicts average tear resistances of each of the Example 4 film, the Example 5 film, and the Example 6 film in the MD and in the CD. In graph 500, a reference number 508 corresponds to the Example 4 film, a reference number 510 corresponds to the Example 5 film, and a reference number 512 corresponds to the Example 6 film.

Graph 500 further includes a seventh bar 508M and an eighth bar 508C depicting the average tear resistances of the Example 4 film in the MD and in the CD, respectively. As depicted by seventh bar 508M, the average tear resistance of the Example 4 film in the MD was about 851 mN. As depicted by eighth bar 508C, the average tear resistance of the Example 4 film in the CD was about 1568 mN.

The Example 4 film exhibited a straight and smooth tear in the MD. Further, the Example 4 film exhibited a non-straight and non-smooth tear in the CD. BOPP film 106 of the Example 4 film facilitated the straight and smooth tear in the MD while resisting tearing in the CD. It was also noted that sealing film 110 of the Example 4 film had thickness 110T of 60 microns.

Graph 500 further includes a ninth bar 510M and a tenth bar 510C depicting average tear resistances of the Example 5 film in the MD and in the CD, respectively. As depicted by ninth bar 510M, the average tear resistance of the Example 5 film in the MD was about 2197 mN. As depicted by tenth bar 510C, the average tear resistance of the Example 5 film in the CD was about 3095 mN.

The Example 5 film exhibited a non-straight or non-smooth tear (not both) in the CD. However, the Example 5 film exhibited a worse tearing performance (not a smooth and straight tear) in the MD as compared to the Example 2, Example 3, and Example 4 films. It was noted that sealing film 110 of the Example 5 film had thickness 110T of 80 microns (greater than 70 microns). It was concluded that thickness 110T of 80 microns caused the worse tearing performance of the Example 5 film as compared to the Example 2, Example 3, and Example 4 films.

Graph 500 further includes an eleventh bar 512M and a twelfth bar 512C depicting the average tear resistances of the Example 6 film in the MD and in the CD, respectively. As depicted by eleventh bar 512M, the average tear resistance of the Example 6 film in the MD was about 3216 mN. As depicted by twelfth bar 512C, the average tear resistance of the Example 6 film in the CD was about 4767 mN.

The Example 6 film exhibited a non-straight and non-smooth tear in the CD. However, the Example 5 film exhibited a worse tearing performance (non-straight and a non-smooth tear) in the MD as compared to the Example 6 film. It was noted that sealing film 110 of the Example 6 film had thickness 110T of 100 microns. It was concluded that thickness 110T of 100 microns caused the worse tearing performance of the Example 6 film as compared to the Example 5 film.

It was concluded that thickness 110T of sealing film 110 impacted the average tear resistances of the Example 4, Example 5, and Example 6 films in the MD and in the CD. As thickness 110T increased, the tear resistances of the Example 4, Example 5, and Example 6 films in the MD and in the CD also increased.

Referring to Example 7, graph 500 further depicts average tear resistances of the Example 7 film in the MD and in the CD. In graph 500, the Example 7 film is represented by a reference number 514.

Graph 500 further includes a thirteenth bar 514M and a fourteenth bar 514C depicting the average tear resistances of the Example 7 film in the MD and in the CD, respectively. As depicted by thirteenth bar 514M, the average tear resistance of the Example 7 film in the MD was about 960 mN. As depicted by fourteenth bar 514C, the average tear resistance of the Example 7 film in the CD was about 1944 mN. The Example 7 film exhibited a smooth and/or straight tear in the MD. Further, the Example 7 film exhibited a non-straight and non-smooth tear in the CD.

It was noted that supporting film 108 of the Example 7 film included the blown HDPE film and had thickness 108T of 50 microns. That is, even with a relatively thick (50 microns) supporting film 108, the Example 7 film exhibited the smooth and/or straight tear in the MD. The Example 7 film including a combination of the blown HDPE film and BOPP film 106 exhibited straight and smooth tear not as clean as Example 2, 3, 4 but better than Example 5 and 6.

Referring to Examples 8 and 9, graph 500 further depicts the average tear resistances of each of the seventh and Example 9 films in the MD and in the CD. In graph 500, the Example 8 film is represented by a reference number 516, and the Example 9 film is represented by a reference number 518.

Graph 500 further includes a fifteenth bar 516M and a sixteenth bar 516C depicting the average tear resistances of the Example 8 film in the MD and in the CD, respectively. As depicted by fifteenth bar 516M, the average tear resistance of the Example 8 film in the MD was about 2233 mN. As depicted by sixteenth bar 516C, the average tear resistance of the Example 8 film in the CD was about 3374 mN.

The Example 8 film exhibited a non-straight and non-smooth tear in both the MD and the CD.

Graph 500 further includes a seventeenth bar 518M and an eighteenth bar 518C depicting the average tear resistances of the Example 9 film in the MD and in the CD, respectively. As depicted by seventeenth bar 518M, the average tear resistance of the Example 9 film in the MD was about 1271 mN. As depicted by eighteenth bar 518C, the average tear resistance of the Example 8 film in the CD was about 2477 mN.

The Example 9 film exhibited a better tearing performance in the MD as compared to the Example 8 film. However, the Example 9 film exhibited a worse tearing performance in the MD than the Example 2, Example 3, and Example 4 films. Further, the Example 9 film exhibited a non-straight and non-smooth tear in the CD.

It was noted that the Example 8 film included the PE film free of HDPE, in contrast to the Example 9 film which included the PE film including HDPE. As discussed above, the Example 9 film exhibited a better tearing performance in the MD as compared to the Example 8 film. It was concluded that HDPE incorporation in the Example 9 film may have caused the better tearing performance in the MD as compared to the Example 8 film. However, despite having a lower tear resistance in the MD as compared to the Example 8 film, the Example 9 film did not exhibit a straight and smooth tear.

It was concluded that incorporating a very thin BOPP layer (which constitutes to a limited amount of polypropylene) in a mono-PE structure can be beneficial to provide enhanced dimensional stability without compromise on sealing performance. More surprisingly, it was further concluded that a combination of very thin BOPP with a supporting film such as MDOPE film or blown HPDE film, and low SIT PE sealing film provides efficient functionality regarding easy linear tear in the MD while improving tear resistance in the CD.

Each and every document cited in this present application, including any cross referenced, is incorporated in this present application in its entirety by this reference, unless expressly excluded or otherwise limited. The citation of any document is not an admission that it is prior art with respect to any embodiment disclosed in this present application or that it alone, or in any combination with any other reference or references, teaches, suggests, or discloses any such embodiment. Further, to the extent that any meaning or definition of a term in this present application conflicts with any meaning or definition of the same term in a document incorporated by reference, the meaning or definition assigned to that term in this present application governs.

Unless otherwise indicated, all numbers expressing sizes, amounts, ranges, limits, and physical and other properties used in the present application are to be understood as being preceded in all instances ay the term “about”. Accordingly, unless expressly indicated to the contrary, the numerical parameters set forth in the present application are approximations that can vary depending on the desired properties sought to be obtained by a person of ordinary skill in the art without undue experimentation using the teachings disclosed in the present application.

As used in the present application, the singular forms “a”, “an”, and “the” encompass embodiments having plural referents, unless the context clearly dictates otherwise. As used in the present application, the term “or” is generally employed in its sense including “and/or”, “unless” the context clearly dictates otherwise.

Spatially related terms, including but not limited to, “lower”, “upper”, “beneath”, “below”, “above”, “bottom” and “top”, if used in the present application, are used for ease of description to describe spatial relationships of an element(s) to another. Such spatially related terms encompass different orientations of the device in use or operation, in addition to the particular orientations depicted in the figures and described in the present application. For example, if an object depicted in the drawings is turned over or flipped over, elements previously described as below, or beneath other elements would then be above those other elements.

The drawings show some but not all embodiments. The elements depicted in the drawings are illustrative and not necessarily to scale, and the same (or similar) reference numbers denote the same (or similar) features throughout the drawings.

The description, examples, embodiments, and drawings disclosed are illustrative only and should not be interpreted as limiting. The present invention includes the description, examples, embodiments, and drawings disclosed; but it is not limited to such description, examples, embodiments, or drawings. As briefly described above, the reader should assume that features of one disclosed embodiment can also be applied to all other disclosed embodiments, unless expressly indicated to the contrary. Modifications and other embodiments will be apparent to a person of ordinary skill in the packaging arts, and all such modifications and other embodiments are intended and deemed to be within the scope of the present invention.

1. A packaging film comprising:
a biaxially oriented polypropylene (BOPP) film comprising a thickness between 1 micron (μm) and 10 μm,
a supporting film comprising polyethylene, and
a sealing film comprising polyethylene, the sealing film located on a first exterior surface of the packaging film.

2. The packaging film according to claim 1, wherein the supporting film comprises a polyethylene content greater than 95%, by weight.

3. The packaging film according to claim 1, wherein the supporting film is a machine direction oriented polyethylene film.

4. The packaging film according to claim 1 or 2, wherein the supporting film is non-oriented.

5. The packaging film according to claim 1, wherein the supporting film comprises high-density polyethylene.

6. The packaging film according to claim 1, wherein the supporting film is a polyethylene film comprising a density greater than 0.93 g/cm³.

7. The packaging film according to claim 1, wherein the BOPP film is located on a second exterior surface of the packaging film.

8. The packaging film according to claim 1, wherein the BOPP film is located between the supporting film and the sealing film.

9. The packaging film according to claim 1, wherein the BOPP film comprises a thickness between 1 μm and 6 μm.

10. The packaging film according to claim 1, wherein the packaging film comprises a polyolefin content between 90% and 100%, by weight.

11. The packaging film according to claim 1, wherein the packaging film comprises a polyethylene content between 85% and 95%, by weight.

12. The packaging film according to claim 1, wherein the sealing film comprises a polyethylene content between 90% and 100%, by weight.

13. The packaging film according to claim 1, wherein the sealing film comprises a thickness less than 70 μm.

14. The packaging film according to claim 1, wherein the sealing film comprises a thickness between 50 μm and 70 μm.

15. The packaging film according to claim 1, wherein the sealing film comprises an overall density between 0.88 g/cm³ and 0.93 g/cm³.

16. The packaging film according to claim 1, wherein the BOPP film comprises homopolymer polypropylene.

17. The packaging film according to claim 1, wherein the BOPP film is attached to the supporting film by an adhesive layer.

18. The packaging film according to claim 1, further comprising printed indicia.

19. The packaging film according to claim 1, wherein the packaging film is free of polyester film and metal foil.

20. The packaging film according to claim 1, wherein the packaging film is free of polyester film, polyamide, and metal foil.
